(19) United States
(12) Patent Application Publication
(10) Pub. No.: US 2008/0192508 A1
(43) Pub. Date: Aug. 14, 2008

(54) Method of Lighting a Cabinet or Display Case and Lighting Assembly Therefore

(75) Inventor: Eddie Wayne Busby, Garland, TX (US)

Correspondence Address: SALTER & MICHAELSON;THE HERITAGE BUILDING, 321 SOUTH MAIN STREET, PROVIDENCE, RI, 029037128, US

(73) Assignee: Skip Busby Consulting LLC

(21) Appl. No.: 11/969,136

(22) Filed: Jan. 3, 2008

Related U.S. Application Data
(60) Provisional application No. 60/888,884, filed on Feb. 8, 2007.

(51) Int. Cl. H01R 33/00; H05B 41/36; H01R 13/66; F21V 29/00

(52) U.S. Cl. 362/647; 315/291; 439/620.02; 362/294

(57) ABSTRACT

A fluorescent lighting assembly for a cabinet or display case may be retrofitted to provide non-fluorescent lighting of the cabinet or display case by providing an existing fluorescent lighting system of the cabinet or display case having a socket for receiving a fluorescent lamp. The socket has electrical contacts for providing current to the fluorescent lamp and is powered by a power source. An LED lighting assembly is configured for engaging the socket when the fluorescent lamp is removed so that the LED lighting assembly is held in place by the socket. The LED lighting assembly includes a base configured for coupling to the existing socket of the fluorescent lighting system and an electrical connector for engaging the contacts of the socket. The LED lighting assembly further includes a current converter electrically coupled to the electrical connector for altering current from the power source to provide an electrical output suitable for driving an LED light source and at least one LED light source electrically coupled to the current convertor.

### CROSS-REFERENCE TO RELATED APPLICATIONS

This application claims the benefit of U.S. Provisional Patent Application No. 60/888,884, filed Feb. 8, 2007, which is herein incorporated by reference in its entirety.

### BRIEF DESCRIPTION OF THE DRAWINGS

For a more complete understanding of the present invention, and the advantages thereof, reference is now made to the following descriptions taken in conjunction with the accompanying figures, in which:

FIG. 1 is a front elevational view of a display case employing lighting fixtures for lighting of the display case;

FIG. 2 is a bottom plan view of a conventional fluorescent lighting system for a fluorescent light, with the fluorescent lamp of the lighting system removed;

FIG. 3 is a cross-sectional view of the lighting system of FIG. 2 taken along the lines 3-3 and showing a socket of the fluorescent lighting system;

FIG. 4 is a bottom plan view of an LED lighting assembly that may be used for retrofitting in the fluorescent lighting system, such as that of FIGS. 2 and 3;

FIG. 5 is an elevational side view of the LED lighting assembly of FIG. 4;

FIG. 6 is an elevational end view of the LED lighting assembly of FIGS. 4 and 5;

FIG. 7 is an elevational side view of another embodiment of an LED lighting assembly that may be used with the lighting system of FIGS. 2 and 3;

FIG. 8 is an elevational end view of the LED lighting assembly of FIG. 7 with the lighting source of the LED lighting assembly being rotated relative to a base of the lighting assembly; and

FIG. 9 is an elevational side view of another embodiment of an LED lighting assembly that may be used with the lighting system of FIGS. 2 and 3.

### DETAILED DESCRIPTION

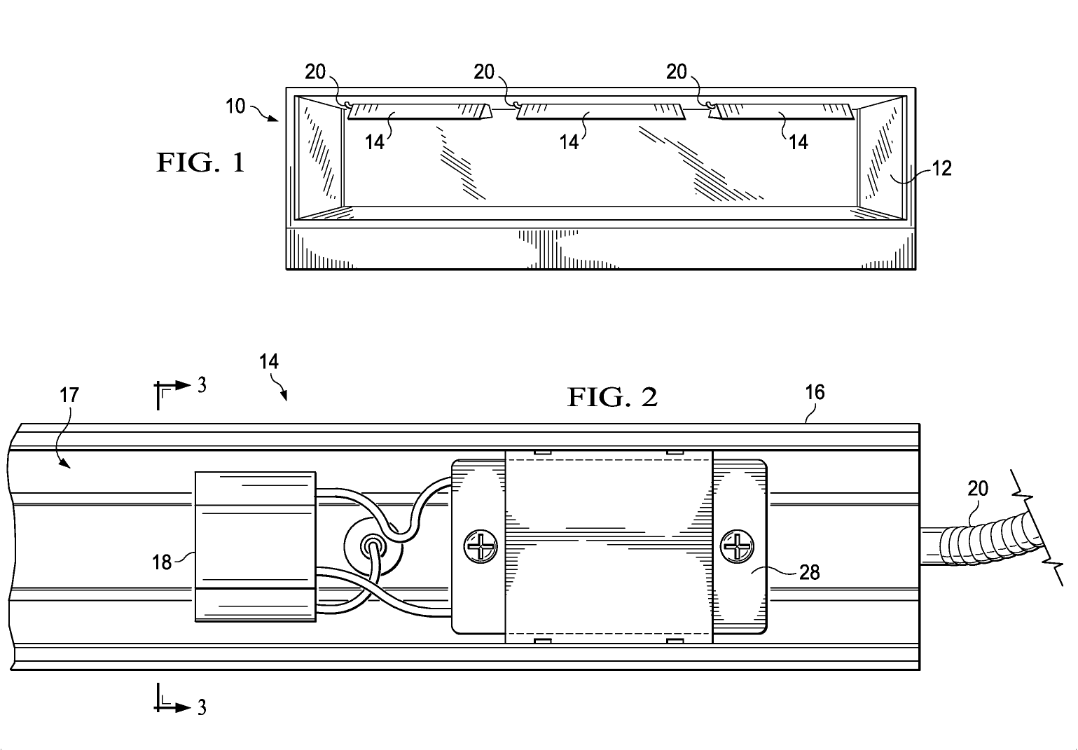

Referring to FIG. 1, a cabinet or display case 10, such those used in retail stores and the like, for displaying items or objects within the case 10 offered for purchase is shown. The display case 10 is constructed with glass or transparent walls 12 for allowing objects within the case 10 to be readily seen. To facilitate viewing of objects within the case 10, one or more lighting systems 14 are mounted to or positioned within or near the case 10. The lighting systems 14 typically used are conventional fluorescent lighting systems that employ a fluorescent lamp or lamps. In the embodiment shown, the lighting systems 14 are mounted at or near the top of the display case.

While the lighting system or systems 14 described herein are shown being used for glass or transparent display cases, such as those used in retail stores, they can be used in a variety of other areas, such as for under-cabinet lighting in homes, offices, businesses, workspaces and the like, or anywhere lighting is desired, and should not be necessarily limited to any particular application or use.

FIG. 2 shows a more detailed view of the lighting system 14 with a fluorescent lamp of the lighting system 14 removed. The lighting system 14 may be a preexisting lighting system for use with a compact fluorescent lamp (CFL) such as that used for PL-13 fluorescent lamps or other CFL fluorescent lamps. As used herein, “compact fluorescent lamp” or “CFL” or similar expressions refer to those fluorescent lamps or lighting systems wherein the fluorescent tube of the lamp is generally U-shaped or loop-shaped or the ends of the fluorescent tube return to generally the same end and are generally in close proximity to each other so that the lamp may be plugged into a single socket or plugged into a socket only at one end of the lamp or otherwise electrically coupled at one end of the lamp. Some examples of compact fluorescent lamps are described in U.S. Pat. Nos. 3,191,087; 4,199,708; 4,587,453 and 4,833,574, each of which is incorporated herein by reference.

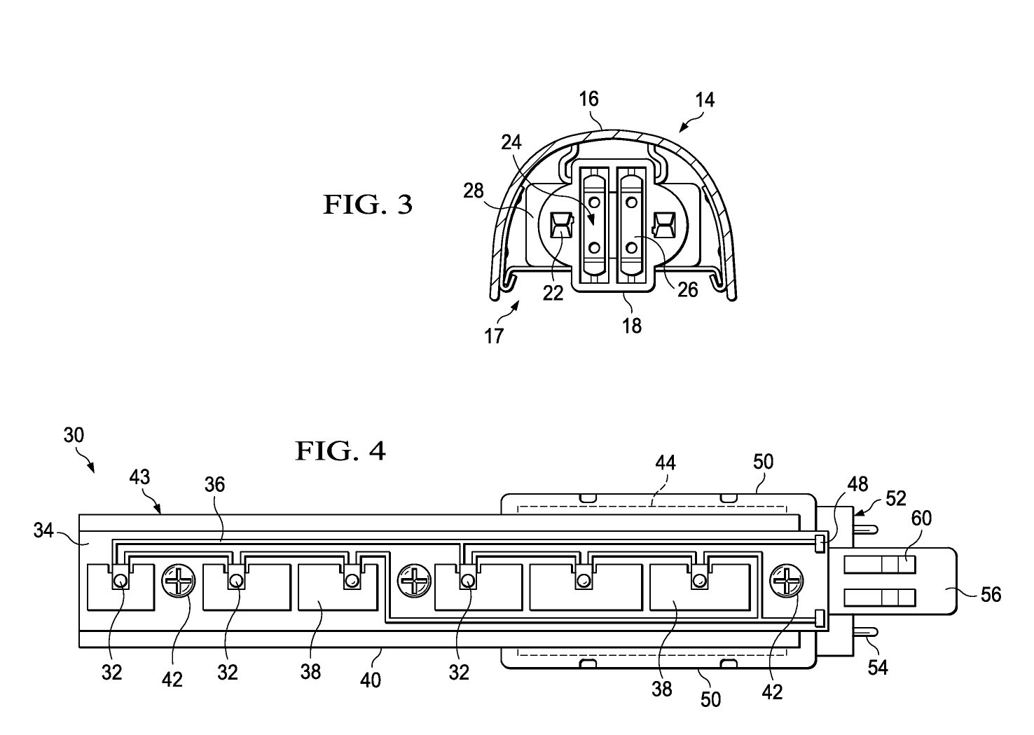

The lighting system 14 may include a shield or housing 16 for housing the lamp and other components of the system 14. The shield 16 may be formed as an elongate channel that is generally open along one side to allow the passage of light from the lamp (not shown) through the open portion 17 (FIG. 3) in a desired direction, and in some embodiments, preventing light from being directed in other directions. The shield 16 may have a generally U- or C-shaped transverse cross section, as shown in FIG. 3, and may be formed from any suitable material, such as metal, plastic, etc., which may be extruded, molded, or otherwise fabricated into the desired shape. The shield 16 may provide a sufficient housing and mounting device for other components of the lighting system 14. The shield 16 may provide an enclosure so that other components of the system 14 may be generally hidden when viewed from the exterior of the shield 16. An optional transparent or translucent cover (not shown), which may be tinted or untinted, may be provided with the shield 16 to cover the open portion 17.

The lighting system 14 is provided with a light socket 18 that is electrically coupled to a power source through power cord 20. The power cord 20 may be provided with a plug (not shown) for plugging into an existing electrical outlet or may otherwise be hardwired to an electrical system sufficient for powering the lighting system 14. A control switch (not shown) for selectively powering the lighting system 14 may also be provided for turning the lamps on and off.

The socket 18 may be that configured for receiving a fluorescent bulb having GX23-type base and is provided with a pair of recessed or apertured electrical contacts 22 (FIG. 3) for receiving prongs of the fluorescent lamp (not shown). It should be noted that the socket 18 may be configured for receiving other fluorescent light bases as well, such as, but not limited to, G23-2, GX23-2, G24D-1, G24D-2, G24D-3, G24Q-1, G24Q-2, G24Q-3, GX24D-2, GX24D-3, GX24Q-1, GX24Q-2, GX24Q-3, GX24Q-4, 2G7, 2G11, 2GX7 and G23 bases. The socket 18 is provided with a recess 24 for receiving a corresponding projecting portion of the base of the PL-13 fluorescent light source. One or more clips or brackets 26 for releasable locking engagement with a corresponding mechanism of the PL-13 lamp base may also be provided. Much of the design and configuration of the socket 18 is to facilitate correct installment of the appropriate fluorescent lamp. Thus, one cannot install a fluorescent lamp into a socket unless it is specifically designed for it.

The socket 18 may be electrically coupled to the power supply through a ballast 28, which is typically used with fluorescent lamps, mounted to the shield 16 or otherwise incorporated into the lighting system 14. When used with a fluorescent lamp, the ballast 28 provides a level of initial voltage to ionize the gas mixture in the fluorescent light unit and then functions as a current limiter having an appropriate impedance to limit the current supplied to the fluorescent light unit to the appropriate value. As is discussed in more detail later on, a light-emitting diode (LED) lighting assembly used with the lighting system 14 is configured to operate with a ballast, such as the ballast 28, disposed in the power supply line, thus facilitating use of the LED light assembly with existing fluorescent lighting fixtures without requiring the ballast 28 to be modified or removed. In other embodiments, the ballast 28 may be removed or modified so that it is no longer coupled to the socket or incorporated into the power supply line. In this way, the LED lighting assembly may receive power directly through the regular line voltage, without the use of any ballast.

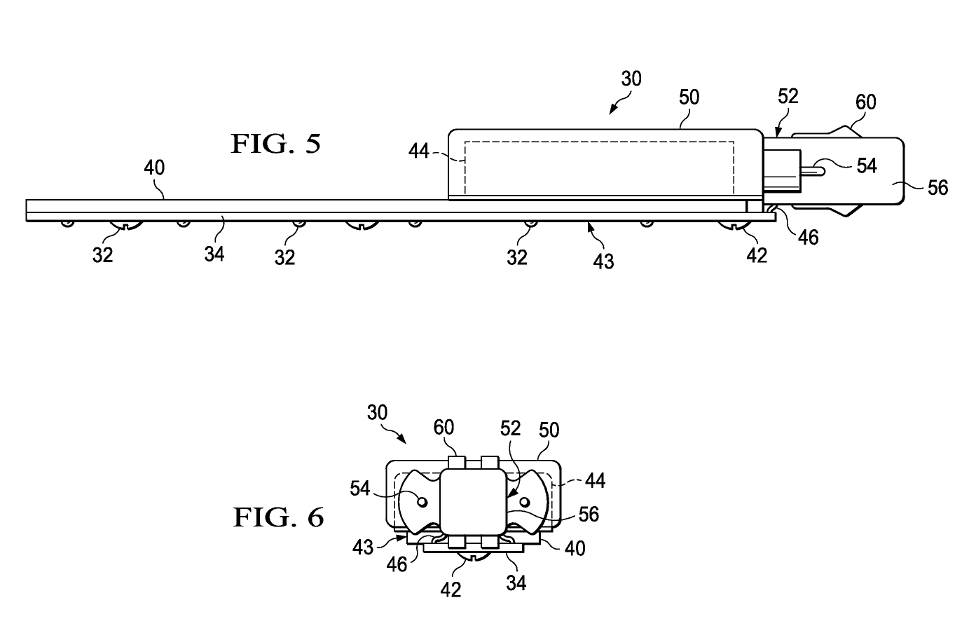

Referring to FIGS. 4-6, one embodiment an LED lighting assembly 30 for use with the lighting system 14 is shown. The lighting assembly 30 includes one or more LED light sources 32. The LED lights 32 may be constructed and formed from a variety of semiconductor materials to provide any desired color of light or wave frequency. LED light sources are known in the art and can be readily obtained commercially from a variety of sources. In certain embodiments, the LED lights 32 may be constructed to emit a white light, the same or similar to natural light. Other colors may also be used, such as blue, red, green, yellow and orange. LED light sources that emit ultraviolet or infrared light may also be used in certain applications.

The LED light sources 32 may provide from about 20 lumens/watt to about 150 lumens/watt per individual light source, with from about 40 lumens/watt to about 100 lumens/watt per light source being more typical. A light source providing about 80 lumens/watt has been found to be well suited for many applications. Examples of commercially available LED light sources are the LUXEON® I and LUXEON® Rebel LED light emitters, available from Phillips Lumileds Lighting Company, San Jose, Calif. As shown in FIG. 4, there are six LED light sources that are mounted to an elongated panel 34 in a generally linear array or configuration. In certain embodiments, anywhere from one to about 10 or more light sources may be used, with from about 2 to about 8 LED light sources being typical. The light sources may be spaced apart from ½ inch to 2 inches or more, with from about ¾ inch to about 1.5 inches being typical. In the embodiment shown, the light sources 32 are linearly spaced apart approximately 1 inch along the length of the panel 34. The LED light sources may be arranged in non-linear, staggered or other configurations, as well. The LED light array may provide from about 400 to about 800 or more lumens, with from about 450 lumens to about 500 lumens being typical. An example of a suitable output for the LED light source array may be about 480 lumens. Lumen measurements may be measured at a distance of about 18 inches from the light sources.

It should be noted that the description and embodiments described are presented solely for the purpose of illustrating the invention and should not be necessarily construed as a limitation to the scope and applicability of the invention. In the description, each numerical value should be read once as modified by the term “about” (unless already expressly so modified), and then read again as not so modified unless otherwise indicated in context. Also, in the description, it should be understood that a value or range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific values within the range, or even points within the range, are explicitly identified or refer to only a few specific values, it is to be understood that the inventor appreciates and understands that any and all points or values within the range are to be considered to have been specified, and that the inventor is in possession of the entire range and all points within the range.

In the embodiment shown, the panel 34 is in the form of a generally flat printed circuit board (PCP) having circuitry 36 for supplying electrical power to each of the light sources 32. The circuitry 36 may electrically couple all or some of the light sources 32 in a series or parallel configuration. Additionally, one or more arrays or banks of several lights that are coupled in series may be wired so that the arrays or banks are in parallel or series and vice versa. In many instances, the light sources 32 will be electrically coupled in a series configuration. Pads, holes or other structures may be provided with the panel 34 to facilitate securing the LED lights 32, which may have corresponding pads, pins, etc., to the panel 34. Soldering or other securing means, which may be releasable or non-releasable, may be used to secure or couple the LED light sources 32 to the panel 34.

The panel 34 has a generally flat, rectangular shape, although other shapes and configurations, flat and non-flat, for the panel 34 may be used, as well. The length of the panel 34 is sufficient to provide the desired spacing for the LED light array. Thus, for example, for a linear array of four LED lights spaced approximately one inch apart, the panel may have a length of 5 to 6 inches. Provided in the panel 34 are heat pads or sinks 38, which may generally surround the areas where the LED light sources 32 are secured. The heat pads 38 may extend through all or a portion of the thickness of the panel 34.

The panel 34 is secured or coupled in a closely abutting relationship to a heat transfer assembly 40. In the embodiment shown, the heat transfer assembly 40 serves as a heat sink and is a generally solid, rectangular-shaped member or plate formed from a heat conducting material, such as the metals of aluminum, copper, steel, etc., to facilitate heat transfer away from the LED light sources 32 and panel 34. Other configurations for the heat transfer member 40 may be used as well and these may correspond to fit in a close abutting relationship with the panel 34. Aluminum is particularly well suited for the heat transfer member 40 because of its heat transfer properties and its lightweight. The heat pads 38 of the panel 34 may be in close or direct contact with the heat transfer member 40.

The panel 34 may be secured to the heat transfer member 40 through screws or fasteners 42. The screws or fasteners 42 may be of a highly heat conductive material and may pass through the thickness of the panel 34 and into the heat transfer member 40 to facilitate heat transfer from the panel 34 to the plate 40. The fasteners 42 may also pass through the heat sinks 38 of the panel 34. The combined panel 34 with the light sources 32 and heat transfer member 40 form an elongated LED lighting strip 43. An optional transparent or translucent cover (not shown) may be provided with the LED lighting strip for covering of the LED lights 32.

The amount of heat transferred away by the heat transfer member 40 and components of the LED light assembly 30 should provide sufficient heat transfer so that the assembly is generally maintained at a temperature at from about 150° F. or less, with from about 65° F. to about 100° F. being typical.

The LED light assembly 30 includes a current converter 44. The current converter may be in the form of an LED power driver for converting power or electrical current from a high power supply, such as a standard 100V to 120V AC current, through the power cord 20 and any existing ballast, such as the ballast 28, to provide an appropriate electrical output for powering the LED light sources 32. The input voltage may be, for example, from about 50V to about 300V, although the input voltage may vary. The electrical output from the current converter 44 may be a low voltage DC current, which may include a 5 V, 10V, 12V, 24 V or 27V DC current for powering the LED light sources 32. The output current from the current convertor may be from about 200 mA to about 1 Amp, with from about 350 mA to about 750 mA being typical. An example of a suitable LED power driver is that commercially available as the Xitanium LED Driver, Model No. LEDUNIA700C12F, from Advance Transformer, Rosemont, Ill., which may provide an 8 Watt, 700 mA current output.

Other current converters may also be used to provide a suitable current to the LED light sources. Some elements of the light assembly 30 may be configured to operate on an AC power supply while others a DC. In some embodiments, the current converter may include a controller in the form of hardware, software, firmware or a combination thereof for driving the LED light source assembly 30 at a desired duty cycle. For example, in some embodiments, the current converter may cause illumination or activation of the LED light sources according to a predetermined intermittent rate, such as a pulsed or intermittent activation of the LED lights.

The output of the converter 44 may be electrically coupled through wires 46 to the circuitry 36 of the PCP 34 through contacts 48 (FIG. 4) of the PCP 34. Other electrical coupling means may also be used. The converter 44 may be housed in a driver housing 50 sized and configured for receiving the converter 44. The housing 50 may be mounted to the panel 34 and/or heat transfer member 40 by means of fasteners, such as the fasteners 42. Other fastening or mounting means, such as gluing, bonding, welding, molding, etc., may also be used to mount the housing 50 and converter 44 to the lighting strip 43.

A base 52 may be incorporated with the housing 50 or may otherwise be electrically coupled to the converter 44 and LED lighting strip 43. In the embodiment shown, the base 52 is configured to correspond to the existing socket 18 of the lighting system 14. Accordingly, the base 52 is configured to generally correspond to a GX23-type base. The base 52 may have other configurations as well to correspond to differently configured sockets. Thus, the base 52 may also be configured to correspond to sockets for G23-2, GX23-2, G24D-1, G24D-2, G24D-3, G24Q-1, G24Q-2, G24Q-3, GX24D-2, GX24D-3, GX24Q-1, GX24Q-2, GX24Q-3, GX24Q-4, 2G7, 2G11, 2GX7 and G23 bases as well as other bases.

As a GX-23-type base, the base 52 includes a pair of transversely spaced apart prongs or projecting electrical connectors 54 for being received and making electrical contact with the recessed or aperture contacts 22 of the socket 14. The prongs are electrically coupled to the converter 44 through wires (not shown) or other electrical coupling means to provide current from the power cord 20 and/or ballast 28 to the LED lights 32.

Additionally, the base 52 is provided with a male projecting socket engagement member 56 that is received and corresponds to the recess 24 of the socket 24. The member 56 is formed from a generally blocked-shaped portion that carries a single or pair of upper and lower ramped locking or engagement members 60 that releasably engage the bracket or brackets 26 of the socket 24. The configuration of the base 52 may vary, however. The base 52 may facilitate mounting of the lighting assembly 30 to the lighting system so that no further means is required to hold the lighting assembly 30 in place other than insertion of the base 52 into the socket 18. Further securing means may be provided, however, if desired. A universal base may also be configured so that the base 52 can be installed into a number of different sockets having different configurations. This may be accomplished by elimination or modification of the projecting member 56.

The components of the LED lighting assembly 30 are configured so that the entire lighting assembly 30 fits easily into and is housed within the shield 16 of the lighting system 14. If any transparent or translucent cover (not shown) is provided with the shield 16, the LED lighting assembly may be configured so that it readily fits behind such cover, as well. The entire length of the LED lighting system may be from about 2 inches to about 10 or 12 inches and may have a width across its greatest transverse dimension of from about ¾ inch to about 2 or 3 inches.

In use, the LED lighting assembly 30 merely replaces any existing fluorescent or other lighting assembly that is being used with the lighting system 14. One merely disengages and removes such existing lighting assembly from the socket 18 and replaces it with the LED lighting assembly 30 by merely inserting the base 52 into the socket 18 so that the prongs 54 are in contact with the contacts 22. As current is supplied from the power cord 20 and/or ballast 28, it is modified by the current converter to power the LED light sources 32 to provide light to the display case 10 or other areas for which the light system is being used. There is no need to modify or otherwise configure the lighting system 14 differently to accept the LED lighting assembly 30. The lighting assembly 30 is completely self-contained and requires no additional parts or modification to work with the existing fluorescent lighting system 14.

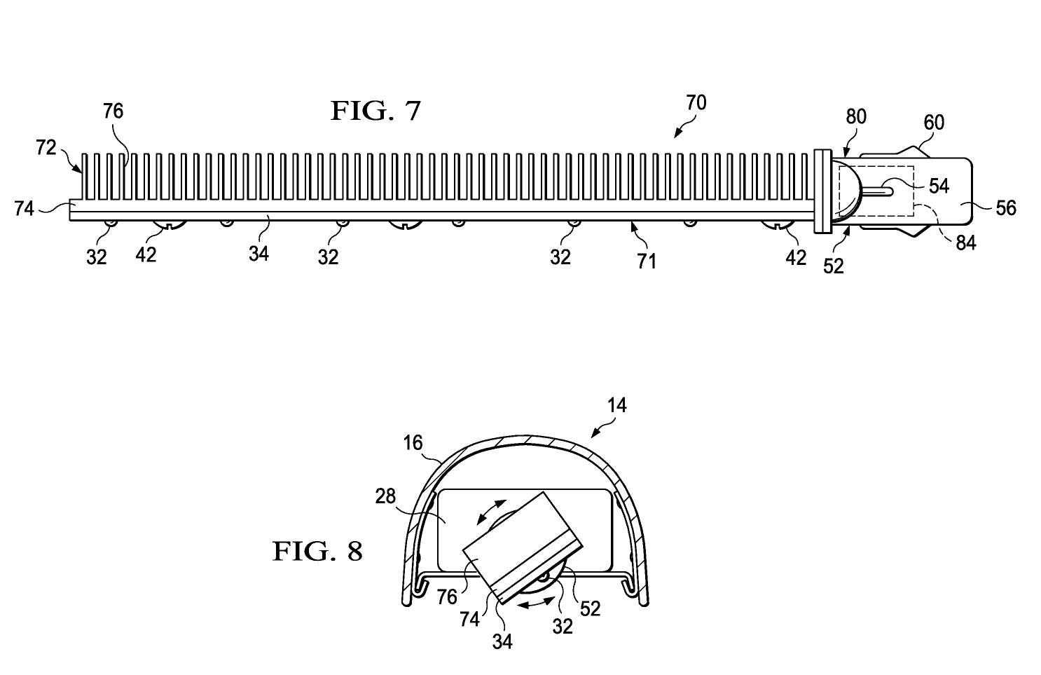

FIGS. 7 and 8 illustrate another embodiment of a LED lighting assembly 70. The LED lighting assembly 70 is similar to the assembly 30, with similar components labeled with the same reference numerals. The assembly 70 differs from the assembly 30 in that the lighting strip 71 is provided with a heat transfer assembly 72 that includes a planar member or plate 74 like the member 40 that includes a plurality of longitudinally spaced apart heat transfer surfaces or fins 72 that extend from the surface of the plate 74 opposite the panel 34 across all or a portion of the width of the plate 74

Additionally, the lighting strip 71 is rotatably mounted to a base 80 so that the lighting strip 71 may be rotated about a longitudinal axis, as indicated by the arrows in FIG. 8, when the base is secured within a corresponding socket, such as the socket 18. This allows the light from the lighting strip 71 to be focused to different orientations without adjusting or rotating the shield 16 or lighting system 14. The lighting strip 71 may be rotated continuously with the strip 71 be held in any position when rotated 360 degrees to provide an infinite number of positions or it may be provided with a releasable locking mechanism so that it can be rotated to a few or a limited number of positions.

The LED lighting assembly 70 also differs in that the power driver 44 is eliminated and instead an integrated circuit (IC) chip 84 is used to convert the current to the appropriate levels for use with the LED lighting strip 71. The IC chip 84 may be housed within the base 80, which may be hollowed to house the IC chip, and is electrically coupled to the circuitry of the lighting strip 71 and the prongs 54 of the base. Examples of suitable commercially available IC chips for current conversion include the VIPer22A and VIPer22A chips, available from STMicroelectronics, which include an integrated current mode PWM and a high voltage power MOFSET on the same chip.

The LED lighting assembly 70 is used in a similar manner to the lighting assembly 30 and is merely plugged into an existing socket of a lighting system, as described with respect to the lighting assembly 30.

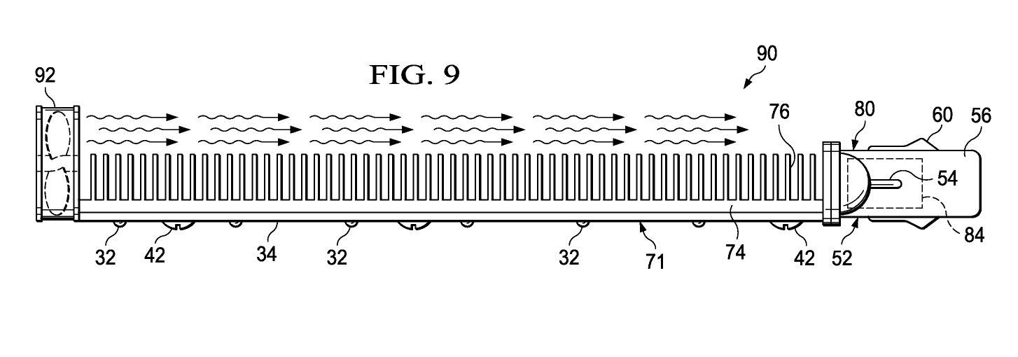

FIG. 9 shows another embodiment of an LED lighting assembly 90. The lighting assembly 90 is similar to the lighting assembly 70 previously described, with similar components labeled with the same reference numerals. The LED lighting assembly 90 further includes a small electric fan 92, such as those CPU fans used with computers and the like, incorporated with lighting strip 71. The fan 92 is electrically coupled to the prongs 54 so that power is directed to the fan 92 from the same power source when the assembly 90 is plugged into the light socket 18.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

1. A method of retrofitting a compact fluorescent lighting assembly for a cabinet or display case to provide non-fluorescent lighting of the cabinet or display case comprising:
providing an existing compact fluorescent lighting system of the cabinet or display case having a socket for receiving a compact fluorescent lamp (CFL), the socket having electrical contacts for providing current to the fluorescent lamp, the fluorescent lighting assembly being powered by a power source;
providing an LED lighting assembly configured for engaging the socket so that the LED lighting assembly is held in place by the socket, the LED lighting assembly comprising:
a base configured for coupling to the existing socket of the fluorescent lighting system;
an electrical connector for engaging the contacts of the socket;
a current converter electrically coupled to the electrical connector for altering current from the power source to provide an electrical output suitable for driving an LED light source; and
at least one LED light source electrically coupled to the current convertor;
removing any existing fluorescent lamp from the socket of the fluorescent lighting system and replacing said fluorescent lamp with the LED lighting assembly by coupling the base of the LED lighting system to the socket to thus provide non-fluorescent lighting when the LED lighting system is powered by the power source.

2. The method of claim 1, wherein:
the fluorescent lighting system further includes a ballast electrically coupled to the socket.

3. The method of claim 1, wherein:
the power source is from about a 100V to about a 130V AC power source and the electrical output from the converter is from about a 5 V to about a 30V DC current.

4. The method of claim 1, wherein:
the socket is a GX23-type socket and the base is configured for engagement and coupling to the GX23-type socket.

5. The method of claim 1, wherein:
the at least one LED light source is a plurality of LED light sources are mounted on and electrically coupled together on a panel.

6. The method of claim 5, wherein:
there are from about 2 to about 8 LED light sources arranged in linearly spaced-apart pattern.

7. The method of claim 1, wherein:
the LED light source is rotatable relative to the base to direct emitted light from the LED light source to selected positions.

8. The method of claim 1, wherein:
the LED lighting assembly further comprises a heat transfer assembly to facilitate heat dissipation of the LED light sources, the heat transfer assembly including at least one of a fan, a heat sink with extended surfaces and a heat sink without extended surfaces.

9. The method of claim 1, wherein:
the existing fluorescent lighting system further comprises a shield having an elongated channel for housing components of the fluorescent lighting system, and wherein the LED lighting assembly is configured for being received within the elongated channel.

10. The method of claim 1, wherein:
the at least one LED light source emits a light output of from about 20 lumens/watt to about 150 lumens/watt per LED light source.

11. An LED lighting assembly for a display case to provide non-fluorescent lighting of the display case comprising:
a base configured for coupling to an existing socket of a compact fluorescent lighting system;
an electrical connector for engaging the contacts of the socket;
a current converter electrically coupled to the electrical connector for altering current from a power source unsuitable for an LED light source to provide an electrical output suitable for the LED light source; and
at least one LED light source electrically coupled to the current convertor.

12. The lighting assembly of claim 11, wherein:
the power source is from about a 100V to about a 130V AC power source and the electrical output from the converter is from about a 5 V to about a 30V DC current.

13. The lighting assembly of claim 11, wherein:
the socket is a GX23-type socket and the base is configured for engagement and coupling to the GX23-type socket.

14. The lighting assembly of claim 11, wherein:
the at least one LED light source is a plurality of LED light sources that are mounted on and electrically coupled together on a panel.

15. The lighting assembly of claim 14, wherein:
there are from about 2 to about 8 LED light sources arranged in linearly spaced-apart pattern.

16. The lighting assembly of claim 11, wherein:
the LED light source is rotatable relative to the base to direct emitted light from the LED light source to selected positions.

17. The lighting assembly of claim 11, wherein:
the LED lighting assembly further comprises a heat transfer assembly to facilitate heat dissipation of the LED light sources, the heat transfer assembly including at least one of a fan, a heat sink with extended surfaces and a heat sink without extended surfaces.

18. The lighting assembly of claim 11, wherein:
the LED lighting assembly further comprises a shield having an elongated channel for receiving and housing components of the LED lighting assembly.

19. The lighting assembly of claim 11, wherein:
the at least one LED light source provides a light output of from about 20 lumens/watt to about 150 lumens/watt per LED light source.

20. The lighting assembly of claim 17, wherein:
the heat transfer assembly facilitate heat dissipation of the LED light sources to generally maintain the temperature of the light assembly at a temperature of from about 150° F. or less.
